(19) United States
(12) Patent Application Publication
(10) Pub. No.: US 2018/0345549 A1
(43) Pub. Date: Dec. 6, 2018

(54) FORMING DEVICE AND METHOD OF BASE MATERIAL AND SKIN LAYER

(71) Applicants: Hyundai Motor Company, Seoul (KR); Kia Motors Corporation, Seoul (KR); Adient Automotive Interiors Korea Inc., Pyeongtaek-si (KR)

(72) Inventors: Wansu PARK, Gurye-eup (KR); Seok Kyu CHOI, Cheonan-si (KR)

(73) Assignees: Hyundai Motor Company, Seoul (KR); Kia Motors Corporation, Seoul (KR); Adient Automotive Interiors Korea Inc., Pyeongtaek-si (KR)

(21) Appl. No.: 15/828,248

(22) Filed: Nov. 30, 2017

(30) Foreign Application Priority Data
May 31, 2017 (KR) 10-2017-0067502

(51) Int. Cl. B29C 45/00; B29C 45/14; B60R 13/02

(52) U.S. Cl. CPC B29C 45/0062; B29L 2031/3041; B60R 13/0243; B29C 45/14786

(57) ABSTRACT

A forming device of a base material and a skin layer may include a lower mold having an upper surface on which a first forming surface is formed and including a vacuum path formed inwardly from the first forming surface to be connected to the vacuum chamber; an upper mold disposed to be movable upward and downward by a press device and having a lower surface on which a second forming surface is formed to correspond to the first forming surface of the lower mold; a pressurizing member disposed at the outside of the second forming surface of the upper mold to be movable toward the upper surface of the lower mold; and a pressurizing cylinder pushing the pressurizing member toward the upper surface of the lower mold to closely adhere the skin layer injected between the upper mold and the lower mold to the upper surface of the lower mold.

### CROSS-REFERENCE TO RELATED APPLICATION

The present application claims priority to Korean Patent Application No. 10-2017-0067502 filed on May 31, 2017, the entire contents of which is incorporated herein for all purposes by this reference.

### BACKGROUND OF THE INVENTION

### Field of the Invention

The present invention relates to a forming device and method of a base material and a skin layer configured for performing a process of forming a base material, injecting a resin using the formed base material, and compressing a skin layer on the formed product under vacuum in a single mold device.

### Description of Related Art

Generally, examples of a vehicle internal trim may include a door trim, a pillar trim, a package trim, a head lining, and the like, and shapes and materials thereof are significantly various.

To upgrade a product, a shape or pattern including an embossing pattern, or the like, is formed on a surface of the vehicle internal material which forms the internal trim as described above.

Generally, the vehicle internal material includes a soft skin layer and a base material adhered to an internal to the skin layer. The soft skin layer may be made of non-woven fabric, fabric, polyvinyl chloride (PVC) leather, PVC, thermoplastic olefin (TPO), polypropylene (PP) foam, polyethylene (PE) foam, polyurethane (PU) foam, or the like.

Furthermore, the skin layer may include a surface layer having an embossed external surface and an inside layer adhered to an internal to the surface layer, and the surface layer of the skin layer may be made of a relatively light synthetic resin material including PVC, TPO, or the like, to form a surface of a door trim.

Furthermore, the inside layer is made of a material having shock absorption and a predetermined cushion function such as PP foam, PE foam, or the like, and adhered to the internal to the surface layer to form the skin layer.

To form an internal material having the above-mentioned configuration, for example, vacuum forming processes of press-forming a base material having air-permeability, injecting a synthetic resin on the formed base material, and adhering a skin layer on a surface of the formed product is required, and research into a technology for performing these processes in a single mold device has been conducted.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a forming device and method of a base material and a skin layer having advantages of forming a base material, injecting a resin thereon, and compressing a skin layer on the base material by a vacuum formation method using a single mold device.

Various aspects of the present invention are directed to providing a forming device of a base material and a skin layer including: a lower mold having an upper surface on which a first forming surface is formed and including a vacuum path formed inwardly from the first forming surface to be connected to a vacuum chamber; an upper mold disposed to be movable upward and downward by a press device and having a lower surface on which a second forming surface is formed to correspond to the first forming surface of the lower mold; a pressurizing member disposed at the outside of the second forming surface of the upper mold to be movable toward the upper surface of the lower mold; and a pressurizing cylinder pushing the pressurizing member toward the upper surface of the lower mold to closely adhere a skin layer injected between the upper mold and the lower mold to the upper surface of the lower mold.

The pressurizing cylinder may push or pull the pressurizing member through a pressurizing rod.

A fixation pin may be formed to protrude from a lower surface of the pressurizing member.

The pressurizing member may be inserted into and disposed in a groove formed in the lower surface of the upper mold.

A fixation groove may be formed to correspond to the fixation pin in the upper surface of the lower mold.

The upper mold and the lower mold may be disposed to be assembled with each other to form the base material having air permeability, injected between the first and second forming surfaces.

An injection path through which a resin is injected into a space between the first and second forming surfaces may be formed in the lower mold.

The resin injected into the space between the first and second forming surfaces may form a curing portion on a lower surface and an edge portion of the base material.

The skin layer may be attached to a lower surface of the pressurizing member, and the pressurizing member may closely adhere and fix the skin layer to the upper surface of the lower mold by the pressurizing cylinder.

A sealing member sealing a forming space formed by the first and second forming surfaces from the outside may be disposed on the upper surface of the lower mold.

The vacuum chamber may be connected to a vacuum forming portion.

Various aspects of the present invention are directed to providing a forming method of a base material and a skin layer, the forming method including: seating an air permeable base material on a first forming surface of a lower mold; forming the base material by assembling an upper mold having a second forming surface formed thereon with the lower mold; raising the upper mold from the lower mold and attaching a skin layer on a lower surface of a pressurizing member disposed in at least both sides of the upper mold at the outside of the second forming surface; fixing the skin layer to an upper surface of the lower mold by lowering the pressurizing member; and compressing the skin layer on an upper surface of the base material by forming a vacuum state in a space formed between the skin layer and the first forming surface.

The forming method may further include, after the forming of the base material, forming a curing portion by injecting a resin toward a lower surface of the base material and an edge portion of the base material through an injection path formed in the lower mold.

The forming method may further include: pre-heating the base material; and pre-heating the skin layer.

In the attaching of the skin layer, a fixation pin formed to protrude from the lower surface of the pressurizing member may penetrate through or be inserted into the skin layer.

The vacuum state may be formed in the space formed between the skin layer and the first forming surface through a vacuum path connected to the first forming surface of the lower mold.

The forming method may further include, after the attaching of the skin layer, closely adhering a lower surface of the skin layer to the upper surface of the base material by lowering the upper mold at a predetermined distance.

According to an exemplary embodiment of the present invention, productivity may be improved by performing a process of forming the base material having air permeability, injection molding the resin thereon, and compressing the skin layer on the formed product in a single mold device.

Furthermore, quality of an internal material may be improved by continuously binding the base material, an injected portion, and the skin layer in a single mold device to form the internal material.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a cross-sectional view illustrating a forming device of a base material and a skin layer according to an exemplary embodiment of the present invention.

FIG. 2 is a cross-sectional view illustrating a state in which a base material is formed and a resin is injected in the forming device of a base material and a skin layer according to the exemplary embodiment of the present invention.

FIG. 3 is a cross-sectional view illustrating a state in which a skin layer is adhered to a lower surface of an upper mold in the forming device of a base material and a skin layer according to the exemplary embodiment of the present invention.

FIG. 4 is a cross-sectional view illustrating a state in which an upper mold is partially lowered and a pressurizing member pressurizes an edge portion of the skin layer in the forming device of a base material and a skin layer according to the exemplary embodiment of the present invention.

FIG. 5 is a partial cross-sectional view illustrating a state in which a skin layer is compressed on the base material using a vacuum pressure in the forming device of a base material and a skin layer according to the exemplary embodiment of the present invention.

FIG. 6 is a flow chart illustrating a forming method of the base material and a skin layer according to the exemplary embodiment of the present invention.

It may be understood that the appended drawings are not necessarily to scale, presenting a somewhat simplified representation of various features illustrative of the basic principles of the invention. The specific design features of the present invention as disclosed herein, including, for example, specific dimensions, orientations, locations, and the shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, exemplary embodiments of the present invention will be described more specifically with reference to the accompanying drawings.

Since the size and thickness of each element are arbitrarily shown in the drawings for convenience of explanation, the present invention is not necessarily limited thereto, and in the drawings, and the thickness of portions, regions, etc are exaggerated for clarity.

In the accompanying drawings, portions unrelated to the description will be omitted to obviously describe exemplary embodiments of the present invention, and the same reference numerals will be used to describe the same or similar components throughout the present embodiment.

In the following description, the terms ‘“first”, ‘“second”, and the like, will be used to distinguish components having the same names from each other, and will not be necessarily limited to a sequence thereof.

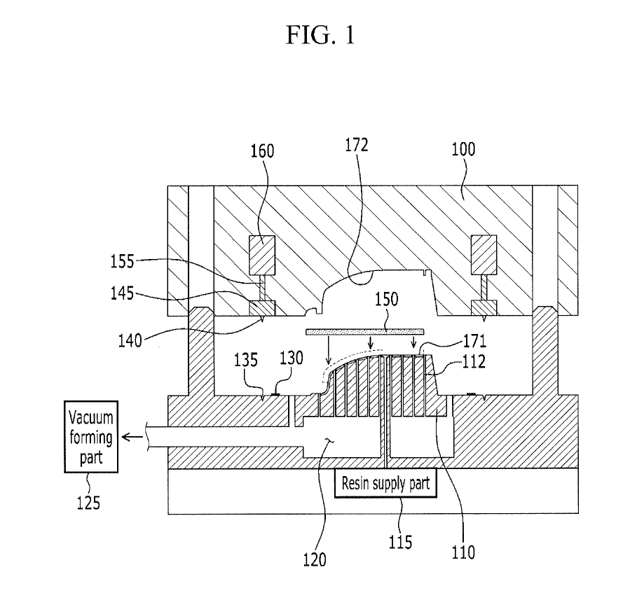

FIG. 1 is a cross-sectional view illustrating a forming device of a base material and a skin layer according to an exemplary embodiment of the present invention.

Referring to FIG. 1, the forming device of a base material and a skin layer includes a lower mold 110, vacuum paths 112, a first forming surface 171, a resin supply portion 115, a vacuum chamber 120, a sealing member 130, a fixation groove 135, a fixation pin 140, a pressurizing member 145, a pressurizing rod 155, a pressurizing cylinder 160, an upper mold 100, a second forming surface 172, and a vacuum forming portion 125 as main components.

A convex first forming surface 171 is formed on a center portion of an upper surface of the lower mold 110, and the vacuum path 112 is formed inwardly of the lower mold 110 from the first forming surface 171.

The vacuum paths 112 are disposed at a predetermined interval and connected to the vacuum chamber 120. Furthermore, the vacuum chamber 120 is connected to the vacuum forming portion 125. Here, the vacuum forming portion 125 may include a vacuum pump, and the like.

The sealing member 130 and the fixation groove 135 are provided on the upper surface of the lower mold 110 at the outside of the first forming surface 171, respectively.

A concave second forming surface 172 is formed to correspond to the first forming surface 171 at a center portion of a lower surface of the upper mold 100, and the pressurizing member 145 is disposed in at least both sides of the upper mold 100 at the outside of the second forming surface 172.

The pressurizing member 145 is inserted into and mounted in a groove (not denoted by a reference numeral) formed in the lower surface of the upper mold 100, and the pressurizing cylinder 160 may pressure the pressuring member 145 downward or pull the pressurizing member 145 upward through the pressurizing rod 155.

Here, the pressurizing cylinder 160 and the pressurizing rod 155 may be formed in the upper mold 100, and the pressurizing cylinder 160 may be operated by air pressure, oil pressure, or a motor.

The fixation pin 140 may be formed to protrude at a center portion of a lower surface of the pressurizing member 145, be inserted into the fixation grooves 135, and be formed to correspond to a shape of the fixation groove 135.

According to the exemplary embodiment of the present invention, a base material 150 is accommodated on the first forming surface 171 of the lower mold 110.

When the base material 150 includes an air permeable material, the base material may include binding or mixing a fiber member including carbon fiber, glass fiber, or glass wool and a resin with each other. Furthermore, in a state in which the upper mold 100 is raised, the pressurizing member 145 may maintain a state in which the pressurizing member 145 is raised to be inserted into the upper mold 100.

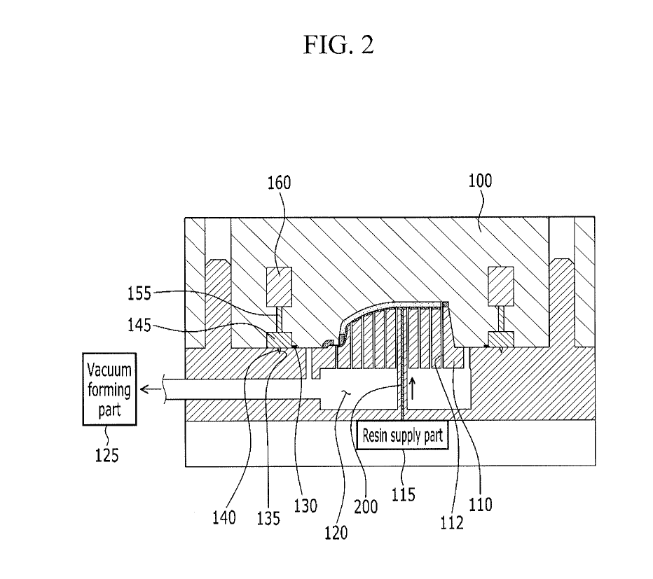

FIG. 2 is a cross-sectional view illustrating a state in which the base material is formed and a resin is injected in the forming device of a base material and a skin layer according to the exemplary embodiment of the present invention.

Referring to FIG. 2, the upper mold 100 is lowered by a press device, and the base material 150 is formed by the second forming surface 172 of the upper mold 100 and the first forming surface 171 of the lower mold 110.

As such, the base material 150 is formed, the resin supply portion 115 injects a resin toward a lower surface of the base material 150 through an injection path 200 formed in the lower mold 110, and the injected resin arrives at the lower surface of the base material 150 and an edge portion of the base material 150.

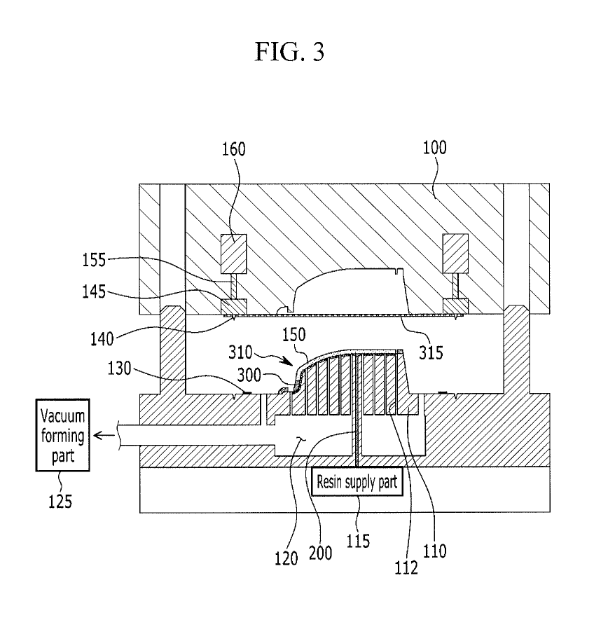

FIG. 3 is a cross-sectional view illustrating a state in which a skin layer is adhered to the lower surface of the upper mold in the forming device of a base material and a skin layer according to the exemplary embodiment of the present invention.

Referring to FIG. 3, the resin injected through the injection path 200 of the lower mold 110 forms a curing portion 300 along the lower surface of the base material 150 and the edge portion of the base material 150.

Here, a formed product 310 includes the base material 150 and the curing portion 300, and the curing portion 300 uniformly maintains a shape of the base materials 150 in a formed shape.

As such, the upper mold 100 is raised, and a skin layer 315 is attached to the lower surface of the upper mold 100 by a worker or a loading device. Here, the fixation pin 140 formed on the lower surface of the pressurizing member 145 penetrates through the skin layer 315 to hold the skin layer 315 to the lower surface of the upper mold.

According to the exemplary embodiment of the present invention, the base material 150 and the skin layer 315 may be pre-heated and injected to the mold device. That is, the base material is accommodated on the forming surface of the upper mold in a pre-heated state, and the skin layer may be attached to the lower surface of the upper mold in a pre-heated state. Here, a pre-heating method and device of the base material and the skin layer are known in the art, and a detailed description thereof will be omitted.

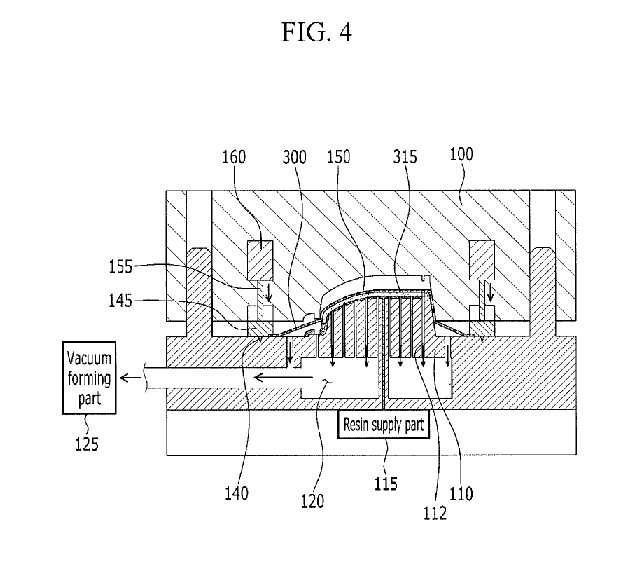

FIG. 4 is a cross-sectional view illustrating a state in which the upper mold is partially lowered and the pressurizing member pressurizes the edge portion of the skin layer in the forming device of a base material and a skin layer according to the exemplary embodiment of the present invention.

Referring to FIG. 4, the upper mold 100 is lowered downward at a predetermined distance, and the skin layer 315 comes in contact with an upper surface of the base material 150. Here, a predetermined distance between the first forming surface 171 of the lower mold 110 and the second forming surface 172 of the upper mold 100 is maintained.

According to the exemplary embodiment of the present invention, the pressurizing member 145 is lowered by the pressurizing cylinder 160, fixing the skin layer 315 to the upper surface of the lower mold 110. Here, the fixation pin 140 formed on the lower surface of the pressurizing member 145 may be inserted into the fixation groove 135 of the lower mold 110 to securely fix the skin layer 315.

Furthermore, the lower surface of the pressurizing member 145 is closely adhered to the sealing member 130 disposed on the upper surface of the lower mold 110, forming a closed space between the skin layer 315 and the upper surface of the lower mold 110.

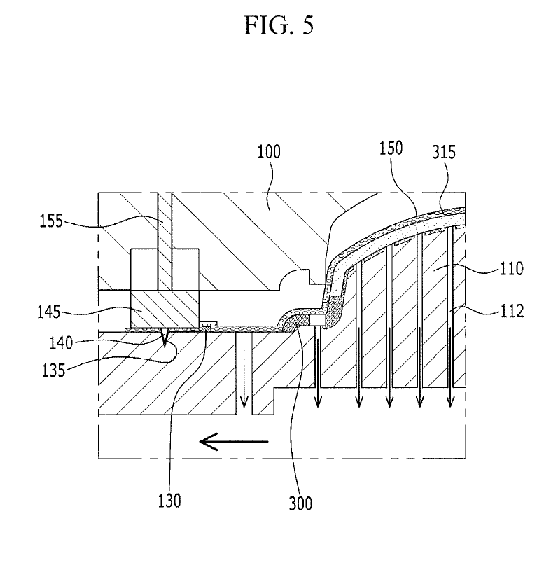

FIG. 5 is a partial cross-sectional view illustrating a state in which the skin layer is compressed on the base material using a vacuum pressure in the forming device of a base material and a skin layer according to the exemplary embodiment of the present invention.

Referring to FIG. 5, the vacuum forming portion 125 forms a vacuum state in the vacuum chamber 120 in the state of FIG. 4.

The skin layer 315 is compressed on upper surfaces of the base material 150 and the curing portion 300 by removing air formed between the skin layer 315 and the lower mold 110 through the vacuum path 112 by a vacuum pressure formed in the vacuum chamber 120.

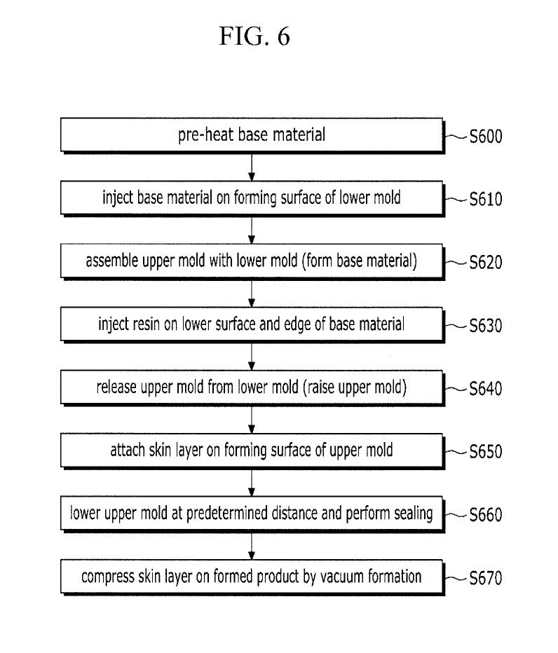

FIG. 6 is a flow chart illustrating a forming method of a base material and the skin layer according to the exemplary embodiment of the present invention.

Referring to FIG. 6, in S600, the base material 150 is pre-heated, and in S610, the base material 150 is accommodated on the first forming surface 171 of the lower mold 110. Here, S600 and S610 may correspond to FIG. 1.

In S620, the upper mold 100 is lowered and assembled with the lower mold 110, and the base material 150 is formed. In S630, the resin is injected into a forming space in which the base material 150 is disposed through the injection path 200 of the lower mold 110. Furthermore, the curing portion 300 is formed by curing the injected resin. Here, S620 and S630 may correspond to FIG. 2.

In S640, the upper mold 100 is raised in a state in which the resin is cured, and in S650, the skin layer 315 is attached to the lower surface of the upper mold 100. Here, the skin layer 315 is penetrated by the fixation pin 140 protruding from the lower surface of the pressurizing member 145. Here, S640 and S650 may correspond to FIG. 3.

In S660, the upper mold 100 is lowered at a predetermined distance, and the pressurizing member 145 is lowered by the pressurizing cylinder 160, closely adhering the skin layer 315 to the upper surface of the lower mold 110. Here, the sealing member 130 is located between the pressurizing member 145 and the lower mold 110, such that a sealing structure is implemented. Here, S660 may correspond to FIG. 4.

In S670, the vacuum forming portion 125 forms a vacuum state in the vacuum chamber 120, and air in the space formed between the skin layer 315, the sealing member 130, and the lower mold 110 is removed through the vacuum path 112, such that the skin layer 315 is compressed on the base material 150 and the curing portion 300. Here, S670 may correspond to FIG. 5.

For convenience in explanation and accurate definition in the appended claims, the terms “upper”, “lower”, “internal”, “outer”, “up”, “down”, “upper”, “lower”, “upwards”, “downwards”, “front”, “rear”, “back”, “inside”, “outside”, “inwardly”, “outwardly”, “internal”, “external”, “internal”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described to explain certain principles of the invention and their practical application, to enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A forming device of a base material and a skin layer, the forming device comprising:
a lower mold having an upper surface on which a first forming surface is formed and including a vacuum path formed inwardly from the first forming surface to be connected to a vacuum chamber;
an upper mold disposed to be movable upward and downward by a press device and having a lower surface on which a second forming surface is formed to correspond to the first forming surface of the lower mold;
a pressurizing member disposed at an outside of the second forming surface of the upper mold to be movable toward the upper surface of the lower mold; and
a pressurizing cylinder configured for pushing the pressurizing member toward the upper surface of the lower mold to adhere the skin layer injected between the upper mold and the lower mold to the upper surface of the lower mold.

2. The forming device of claim 1, wherein
the pressurizing cylinder pushes or pulls the pressurizing member with a pressurizing rod.

3. The forming device of claim 1, wherein
a fixation pin is formed to protrude from a lower surface of the pressurizing member.

4. The forming device of claim 3, wherein
the pressurizing member is inserted into and disposed in a groove formed in the lower surface of the upper mold.

5. The forming device of claim 4, wherein
a fixation groove is formed to correspond to the fixation pin in the upper surface of the lower mold.

6. The forming device of claim 1, wherein
the upper mold and the lower mold are disposed to be assembled with each other to form the base material having air permeability, injected between the first and second forming surfaces.

7. The forming device of claim 6, wherein
an injection path through which a resin is injected into a space between the first and second forming surfaces is formed in the lower mold.

8. The forming device of claim 7, wherein
the resin injected into the space between the first and second forming surfaces forms a curing portion on a lower surface and an edge portion of the base material.

9. The forming device of claim 8, wherein
the skin layer is attached to a lower surface of the pressurizing member, and the pressurizing member adheres and fixes the skin layer to the upper surface of the lower mold by the pressurizing cylinder.

10. The forming device of claim 1, wherein
a sealing member sealing a forming space formed by the first and second forming surfaces from an outside thereof is disposed on the upper surface of the lower mold.

11. The forming device of claim 1, wherein
the vacuum chamber is connected to a vacuum forming portion.

12. A forming method of a base material and a skin layer, the forming method comprising:
seating an air permeable base material on a first forming surface of a lower mold;
forming the base material by assembling an upper mold having a second forming surface formed thereon with the lower mold;
raising the upper mold from the lower mold and attaching the skin layer on a lower surface of a pressurizing member disposed in at least a first side and a second side of the upper mold at an outside of the second forming surface;
fixing the skin layer to an upper surface of the lower mold by lowering the pressurizing member; and
compressing the skin layer on an upper surface of the base material by forming a vacuum state in a space formed between the skin layer and the first forming surface.

13. The forming method of claim 12, further including:
after the forming of the base material,
forming a curing portion by injecting a resin toward a lower surface and an edge portion of the base material through an injection path formed in the lower mold.

14. The forming method of claim 12, further including:
pre-heating the base material; and
pre-heating the skin layer.

15. The forming method of claim 12, wherein
in the attaching of the skin layer,
a fixation pin formed to protrude from the lower surface of the pressurizing member penetrates through or is inserted into the skin layer.

16. The forming method of claim 12, wherein
the vacuum state is formed in the space formed between the skin layer and the first forming surface through a vacuum path connected to the first forming surface of the lower mold.

17. The forming method of claim 12, further including:
after the attaching of the skin layer,
adhering a lower surface of the skin layer to the upper surface of the base material by lowering the upper mold at a predetermined distance.
